(19) United States
(12) Patent Application Publication
(10) Pub. No.: US 2004/0115298 A1
(43) Pub. Date: Jun. 17, 2004

(54) Arrangement including a granulating head, apertured granulating plate

(76) Inventors: Gerhard Hehenberger, Eggendorf (AT); Johannes Remili, Wilhering (AT)

Correspondence Address: ROTHWELL, FIGG, ERNST & MANBECK, P.C., 1425 K STREET, N.W., SUITE 800, WASHINGTON, DC, 20005, US

(21) Appl. No.: 10/682,531

(22) Filed: Oct. 10, 2003

(30) Foreign Application Priority Data
Oct. 22, 2002 (AT) A 1604/2002

(51) Int. Cl. B29B 9/06

(52) U.S. Cl. 425/311; 425/313; 425/382 R; 425/464

(57) ABSTRACT

An arrangement including a granulating head of an extruder for granulating plastics, said granulating head having an end face and comprising a plurality of passage openings for the passage of plastics melt and an apertured granulating plate arranged at said end face of said granulating plate and having apertures following the passage openings, wherein the passage openings each end in a separate socket-shaped projection projecting beyond a front end face of the granulating head and tapering in its cross-section towards a free end, and wherein the apertures taper in their cross-sections to a front running face such that a cutting chamber following on the front running face does not have any contact with the socket-shaped projections; as well as a granulating head; and an apertured granulating plate for the arrangement according to the invention.

### FIELD OF THE INVENTION

The invention relates to an arrangement including a granulating head of an extruder for granulating plastics, said granulating head having an end face and comprising a plurality of passage openings for the passage of plastics melt and an apertured granulating plate arranged at said end face of the granulating head and having apertures following the passage openings.

Furthermore, the invention relates to a granulating head of an extruder for granulating plastics, comprising a plurality of passage openings for the passage of plastics melt and an apertured granulating plate with apertures.

### BRIEF DESCRIPTION OF THE BACKGROUND ART

When granulating plastics, basically there is the problem that in the granulating head and thus in the passage openings a relatively high temperature level prevails so as to reliably avoid setting of the plastics melt, yet that the plastics melt must be cooled very much immediately after its emergence from the passage openings, resulting in a pronounced temperature drop between the granulating head, or the apertured granulating plate, respectively, and the adjacent cutting chamber. In particular during the starting procedure, when—in case of an underwater granulation—a water circulation led through the cutter chamber for cooling the plastics melt must already have been closed before plastics melt emerges from the apertured granulating plate so as to prevent the granular material from forming lumps, this will have the result that cooling water will get into contact with the surface of the apertured granulating plate even before the plastics melt emerges, resulting in a shock-type cooling of the apertured granulating plate. Consequently, the plastics melt may already set in some of the apertures of the apertured granulating plate or in the passage openings of the granulating head, respectively, thereby closing individual apertures, or passage openings, respectively. This in turn will lead to a nonuniform expulsion of the plastics melt from the non-closed passage openings, or apertures, respectively, resulting in a nonuniform granulate. The starting process must then be stopped, and it must be started again. Furthermore, also the clogging of some passage openings, or apertures, respectively, will result in a very high pressure build-up in front of the apertured granulating plate because of the necessity to overcome the solidified plastics melt in the cooled passage openings, or apertures, respectively, and for an increased operating safety of the starting process, a melt pump is required which, however, causes high costs.

Various arrangements of apertured granulating plates at the end side of a granulating head are already known in which a thermal insulation is provided between the apertured granulating plate and the granulating head. For instance, from EP 0739700 A1 a two-part apertured granulating plate is known, in which a protective wear layer comprised of hard metal is provided for abutment of the cutters, and an insulating layer of a ceramic material is arranged between the protective wear layer and the granulating head so as to prevent setting of the plastics melt in the passage openings. Such a construction is, however, complex, and moreover there still is a high risk that plastics melt will solidify in the apertures of the protective wear layer, since the protective wear layer is made of hard metal and thus has a high coefficient of thermal conductivity.

On the other hand, the earlier, not previously published Austrian patent application A 1570/2001 describes a special ceramic apertured granulating plate which simultaneously is provided as a protection against wear and as an insulating layer. Therein, also the formation of socket-shaped projections on the end face of the granulating head is described in which the passage openings of the plastics melt end, the latter, however, merely being provided to secure the apertured granulating plate against rotation on the granulating head. With such a design, however, the end face of the socket-shaped projections will still get into contact with the cold environment in the cutting room—i.e., in case of underwater granulation, with cooling water, so that the setting of the plastics melt in the passage openings, or in the apertures of the apertured granulating plate, respectively, cannot reliably be avoided thereby either.

Furthermore, from U.S. Pat. No. 4,120,625 A, a granulating head comprising an apertured granulating plate is known in which an annular web conically narrowing towards a free end and comprising several passage openings is provided which has a relatively large annular end face that gets into contact with a rotating cutter, and with the cold environment, respectively, in a cutting chamber adjacent the apertured granulating plate so that also here there exists the risk of the plastics melt setting in the passage channel. To form a receiving opening for the web, the apertured granulating plate either is designed in two parts, or it consists of several segments of a circle.

### SUMMARY OF THE INVENTION

It is now an object of the invention to provide an arrangement including a granulating head and an apertured granulating plate, by means of which a setting of the plastics melt in the passage openings of the granulating head, or in the apertures in the apertured granulating plate, respectively, particularly also in the starting process of an underwater granulation can reliably be prevented. Moreover, an appropriate granulating head as well as a respective apertured granulating plate are to be provided for this arrangement.

To achieve the set object, the invention provides an arrangement of the initially defined type, in which the passage openings each end in a separate socket-shaped projection projecting beyond the front end face of the granulating head and tapering in its cross-section towards a free end, and the apertures tapering in their cross-sections towards a front running face such that a cutting chamber following on the front running face does not have any contact with the socket-shaped projections. Thus, an arrangement comprising an apertured granulating plate fastened to the end face of a granulating head is created in which a contact of the mouths of the passage openings with the cool environment of the cutting chamber is avoided so that setting of the plastics melt in the mouth region of the passage openings of the granulating head, in particular also when starting an underwater granulation, is reliably prevented.

Setting of the plastics melt in the passage apertures of the granulating head, or in the apertures of the apertured granulating plate, respectively, may particularly be avoided with an arrangement of the initially defined type in which a clear space is provided for a thermal insulation between the projection, or projections, respectively, of the granulating head and the apertures of the apertured granulating plate, which clear space is filled with an insulating medium. By providing a clear space between the apertures of the apertured granulating plate and the projection, or projections, respectively, of the granulating head, which clear space is filled with an insulating medium, the heat transmission between the apertured granulating plate and the granulating head, i.e. a passing of the cold to the passage openings, is prevented, and thus an undesired setting of the plastics melt still in the passage openings will reliably be prevented.

For a realization of the clear space between the projection(s) of the granulating head and the apertures of the apertured granulating plate in a simple construction, which clear space has a cross-section widening from the running face onwards, it is advantageous if the projections and the apertures are designed to be conical, the cone angle of the apertures being larger than the cone angle of the projections.

Tests have shown that a suitable size of the clear space will result if the difference between the two cone angles is between 5° and 20°, preferably approximately 11°.

If the apertured granulating plate is fastened to the granulating head by means of at least one fastening plate which has an end-side flange engaging in the step of the apertured granulating plate, the transition from the running face of the granulating plate to the end side of the fastening plate being substantially plane, fastening means which project beyond the front running face of the apertured granulating plate and, thus, step-shaped shoulders in which solidified plastics melt could collect, particularly during the starting process, can be avoided.

To obtain the set object, the invention in a second aspect also provides a granulating head which is characterized in that the passage openings each end in a socket-shaped projection projecting beyond a front end face of the granulating head and tapering in its cross-section towards a free end. The projections which taper towards the free end result in a possible simple coverage of the front end faces of the projections by means of the apertured granulating plate, so that the projections practically are not in contact with the cool environment in the cutting chamber, in particular with the cooling water in case of an underwater granulation, whereby cooling of the granulating head in the region around the passage openings is prevented and thus a setting of the plastics melt in the passage openings will reliably be avoided. Moreover, the socket-shaped design of the projections provides a protection against rotation for an apertured granulating plate arranged on the end face of the granulating head.

If the socket-shaped projections taper conically, a configuration of the projections is achieved in which particularly in the foremost end region which faces the cutting chamber and thus the cold environment, a comparatively small area of contact is offered to the cold passed on from the direction of the cutting chamber.

For a simple construction of the granulating head, it is advantageous if the projections are formed in one piece with the granulating head.

If separate inserts are provided as socket-shaped projections in the passage openings, various inserts can be used with the same granulating head, so that inserts of different materials, and with differently sized passage openings, respectively, can be used, depending on the type of the granulate desired.

According to a third aspect, the invention relates to an apertured granulating plate wherein the apertures provided in the circular-ring-shaped apertured granulating plate taper in their cross-sections towards a front running face. By this configuration, a covering of the projections containing the passage openings on the end side of the granulating head is achieved, and thus a contact of the comparatively cool ambient temperature prevailing at the front running face with the passage openings of the granulating head can reliably be prevented.

A particularly good shielding of projections projecting from the granulating head can be achieved if the cross-section of the apertures at least partially tapers continually.

To receive socket-shaped projections of the granulating head, which projections taper conically towards their free ends, it is suitable if the apertures are conical, since this simultaneously will result in a self-centering of the apertured granulating plate in its position fastened to the end face of a granulating head.

If a peripheral step is provided so as to reduce the cross-section of the apertured granulating plate in its operating position towards the running face, the apertured granulating plate can be fastened by means of a plate that engages in the peripherally located step, resulting in a plane, step-free surface in the region of the passage openings. By this—particularly during the starting procedure—it can be avoided that solidified plastics melt will deposit on adjacent projecting steps, by which the rotation of the cutters subsequently could be inhibited.

A material-saving, suitable embodiment of the apertured granulating plate is provided if the circular-ring-shaped apertured granulating plate can have a step on its inner and outer circumference, which step reduces the cross-section of the apertured granulating plate in its operating position towards the running face, so that the circular-ring-shaped apertured granulating plate can be connected to the granulating head by means of a fastening plate engaging in the inward step and a fastening plate engaging in the external step, whereby again steps projecting at the cutting face in the direction of the cutting chamber can be avoided, in which steps undesired plastics melt deposits possibly could form.

The invention will now be explained in more detail by way of preferred exemplary embodiments illustrated in the drawings to which, however, it shall not be restricted.

### BRIEF DESCRIPTION OF THE DRAWINGS

FIG. 1 shows a section through a granulating arrangement with a granulating head in which the passage openings end in projections narrowing in their cross-sections towards the free end;

FIG. 2 shows a top view onto the granulating head according to FIG. 1;

FIG. 3a shows a detailed view of a projection according to FIG. 1 which tapers towards its free end and is formed in one piece with the granulating head;

FIG. 3b shows a detailed view similar to FIG. 3a, yet with a projection formed as a special insert in which the passage opening ends.

### DESCRIPTION OF THE PREFERRED EMBODIMENTS

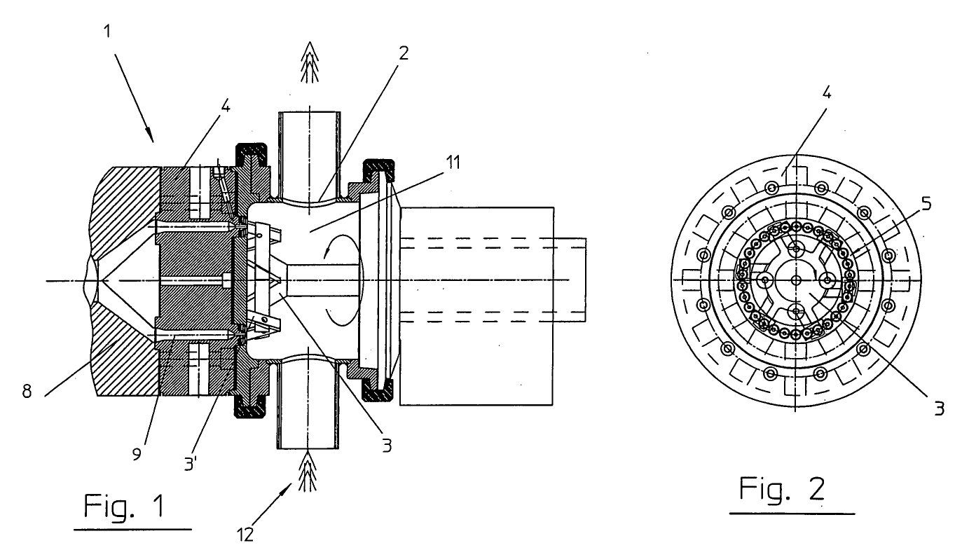

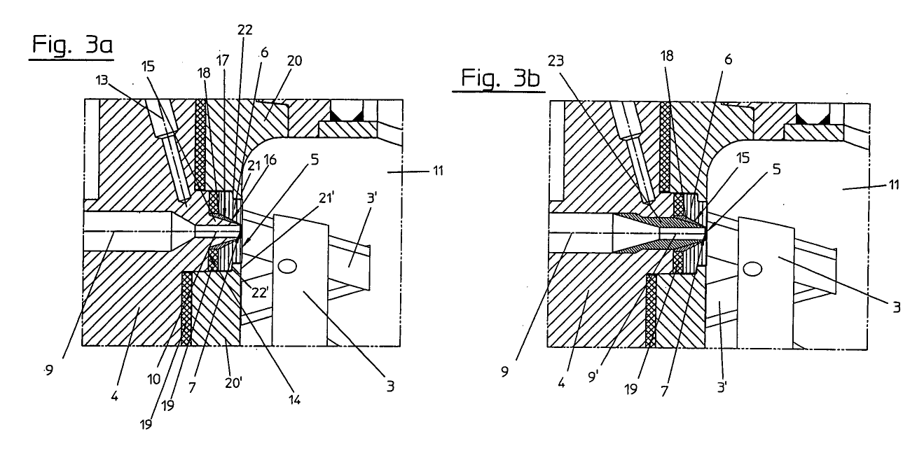

In FIG. 1, a granulating device 1 comprising a granulating housing 2 is visible in which a cutter head 3 is rotatably mounted. The cutter head 3 has cutters 3′ fastened thereto which abut on a forward running face 5 (cf. also FIGS. 3a and 3b) of an apertured granulating plate 6 fastened to a granulating head 4 for granulating the plastics melt emerging from the apertures 7 of the apertured granulating plate 6.

When starting the granulating procedure, at first the granulating housing 2 is closed, the cutter head 3 is adjusted to the running face 5 of the apertured granulating plate 6 with a defined pressure and set into rotation at the desired rpm. Plastics melt is then conducted through a melt starting valve 8 to passage openings 9 in the granulating head 4. At the same time, cooling water is introduced in the direction of arrow 12 into a cutting chamber 11 enclosed by the granulating housing 2.

A considerable temperature gradient thus results between the cutting chamber 11 filled with cooling-water and the granulating head 4 heated by heating cartridges 13, in which granulating head a premature setting of the plastics melt introduced through the passage openings 9 is to be prevented.

As is particularly visible in FIG. 3a, socket-shaped projections 15 are provided at a forward end face 14 of the granulating head 4, which projections 15 have a cross-section which tapers conically towards their free ends so as to offer an area of contact as small as possible to the cooling water present in the cutting chamber 11 with the region surrounding the passage openings 9. This results in a practically non-existent end face of the socket-shaped projections 15 and thus, practically in no area of contact to the cooling water present in the cutting chamber 11.

Accordingly, the apertured granulating plate 6 provided for abutment of the cutters 3 thereon has apertures 16 conically widening from the front running surface face 5 towards the end face 14 of the granulating head. The cone angle of the conically widening apertures 16 of the apertured granulating plate 6 is larger by about 110 than the cone angle of the conically tapering, socket-shaped projections 15 of the granulating head 4, resulting in a clear space 17 between the projections 15 and the apertures 16. This clear space 17 is filled with an insulating medium 18 so that cooling of the socket-shaped projections 15 via the apertured granulating plate 6 is reliably prevented as far as possible. Usually, the apertured granulating plate 6 is made of hard metal and thus has a good coefficient of thermal conductivity; it may, however, also be made of a ceramic material which, if possible, has a poor thermal conductivity so that the temperature of the granulating head 4 can also be kept constant in the socket-shaped projections 15. As the insulating medium 18, any temperature-resistant elastic material, e.g. silicone, can be used. Moreover, the insulating medium 18 serves as an equalizing mass in case of different thermal elongations of the apertured granulating plate 6 and the projections 15 of the granulating head 4.

For the further thermal insulation of the granulating head 4 relative to the cooling-water-filled cutting chamber 11, an insulating layer 19 is attached at the end face 14 of the granulating head 4.

As is particularly visible from FIG. 2, the apertured granulating plate 6 is circular-ring-shaped, and the passage openings 9 as well as the apertures 7 of the apertured granulating plate 6 are evenly distributed over the periphery of the apertured granulating plate 6. The insulating layer 19 is provided both between the apertured granulating plate 6 and the granulating head 4 and between the fastening plates 20, 20′ surrounding the apertured granulating plate 6 and the granulating head 4.

To fasten the apertured granulating plate 6 on the end face of the granulating head 4, the external fastening plate 20 and the inner fastening plate 20′ each have a front-side flange 21, 21′ which engages in an external step 22 and in a peripherally inwardly arranged step 22′ of the apertured granulating plate 6 so that the transition from the running face 5 of the apertured granulating plate 6 to the end side of the fastening plates 20, 20′ facing the cutting chamber 11 will be substantially plane. In this manner, the formation of steps can be avoided in which plastics melt solidified in undesired manner could deposit.

In the exemplary embodiment illustrated in FIG. 3a, the socket-shaped projection 15 is integrally formed with the granulating head 4, resulting in a simple production in one piece.

On the other hand, as is visible in FIG. 3b, also separate inserts 23 can be inserted in the passage openings 9 of the granulating head 4 by which the socket-shaped, conically tapering projections 15 are formed. In this manner, the granulating device 1 can be used for different types of plastics, since depending on the respective requirements, an insert 23 with differently sized passage opening 9′ can be inserted. Moreover, also the material of the insert 23 may be chosen as desired. This results in a granulating device 1 usable in many ways, which, depending on the type of inserts 23 chosen, can be used with the same granulating head 4, and with the same apertured granulating plate 6, respectively, for different types of plastics.

What is claimed is:

1. An arrangement including a granulating head of an extruder for granulating plastics, said granulating head having an end face and comprising a plurality of passage openings for the passage of plastics melt and an apertured granulating plate arranged at said end face of the granulating head and having apertures following the passage openings, wherein the passage openings each end in a separate socket-shaped projection projecting beyond a front end face of the granulating head and tapering in its cross-section towards a free end, and the apertures tapering in their cross-sections to a front running face such that a cutting chamber following on the front running face does not have any contact with the socket-shaped projections.

2. An arrangement according to claim 1, wherein a clear space is provided for a thermal insulation between the projection, or the projections, respectively, of the granulating head and the apertures of the apertured granulating plate, which clear space is filled with an insulating medium.

3. An arrangement according to claim 1 or 2, wherein the projections and the apertures are designed to be conical, the cone angle of the apertures being larger than the cone angle of the projections.

4. An arrangement according to claim 3, wherein the difference between the two cone angles is between 5° and 20°, preferably approximately 11°.

5. An arrangement according to any one of claims 1 to 4, wherein the apertured granulating plate is fastened to the granulating head by means of at least one fastening plate which has an end-side flange engaging in the step of the apertured granulating plate, the transition from the running face of the granulating plate to the end side of the fastening plate being substantially plane.

6. A granulating head of an extruder for granulating plastics, said granulating head having a plurality of passage openings for the passage of plastics melt, wherein the passage openings each end in a socket-shaped projection projecting beyond a front end face of the granulating head and tapering in its cross-section towards a free end.

7. A granulating head according to claim 6, wherein the socket-shaped projections taper conically.

8. A granulating head according to claim 6 or 7, wherein the projections are formed in one piece with the granulating head.

9. A granulating head according to claim 6 or 7, wherein separate inserts are provided as socket-shaped projections in the passage openings.

10. An apertured granulating plate having apertures, wherein the apertures provided in the circular-ring-shaped apertured granulating plate taper in their cross-sections towards a front running face.

11. An apertured granulating plate according to claim 10, wherein the cross-sections of the apertures at least partially taper continually.

12. An apertured granulating plate according to claim 11, wherein the apertures are conical.

13. An apertured granulating plate according to any one of claims 10 to 12, wherein a peripheral step is provided so as to reduce the cross-section of the apertured granulating plate in its operating position towards the running face.

14. An apertured granulating plate according to claim 13, wherein the circular-ring-shaped apertured granulating plate has a step on its inner and outer circumference, which step reduces the cross-section of the apertured granulating plate in its operating position towards the running face.
